(19) United States
(12) Patent Application Publication
(10) Pub. No.: US 2008/0201426 A1
(43) Pub. Date: Aug. 21, 2008

(54) DISTRIBUTED MIXER FOR ON-LINE AUDIO COLLABORATION

(76) Inventor: THOMAS DARCIE, Victoria (CA)

Correspondence Address: MALDJIAN & FALLON LLC, 365 BROAD ST. , 3RD FLOOR, RED BANK, NJ, 07701, US

(21) Appl. No.: 12/041,475

(22) Filed: Mar. 3, 2008

Related U.S. Application Data
(63) Continuation-in-part of application No. 11/740,794, filed on Apr. 26, 2007.
(60) Provisional application No. 60/796,396, filed on May 1, 2006.
(60) Provisional application No. 60/892,810, filed on Mar. 2, 2007.

(51) Int. Cl. G06F 15/16

(52) U.S. Cl. 709/204

(57) ABSTRACT

Embodiments of the present invention generally relate to a system and method of processing data signals. More specifically, in one embodiment, system architecture splits mixing functions between client and server to enable dynamic switching between a client-server and a peer-to-peer paradigm. In another embodiment, architecture allows one to efficiently trade-off computation in the server and link bandwidth in the network. In another embodiment a system is provided to minimize computational load on server subject to link bandwidth constraint. In another embodiment a system is provided to maximize use of client computational resources. In another embodiment a system is provided to adapt to changing network environments and changing service requirements (e.g. number of clients).

### CROSS-REFERENCE TO RELATED APPLICATIONS

This application is a continuation-in-part of U.S. patent application Ser. No. 11/740,794, filed Apr. 26, 2007, entitled “System and Method for Processing Data Signals,” which claims its earliest benefit to U.S. Provisional Patent Application Ser. No. 60/796,396, filed May 1, 2006, entitled “System and Method for Transmitting Audio Signals,” the disclosures of which are incorporated herein by reference in their entireties. This application also claims the benefit of U.S. Provisional Patent Application Ser. No. 60/892,810, filed Mar. 2, 2007, entitled “Distributed Mixer for On-Line Audio Collaboration,” which is incorporated herein by reference in its entirety.

### BACKGROUND

1. Field of the Invention

Embodiments of the present invention are generally related to an audio mixer. More specifically, embodiments of the present invention relate to a distributed mixer for on-line audio collaboration.

2. Description of the Related Art

The current methods for networked audio communication can be divided into two existing paradigms—peer-to-peer and server-client. In the former, each client transmits/receives audio stream to/from other clients directly over a network. Each client receives one or more audio streams from the other clients that are combined for simultaneous playback using an standard audio mixer. In the server client paradigm, multiple clients send audio streams upstream to a single server. The server combines the audio streams using an audio mixer and transmits (identical or client-specific) mixes downstream to each of the clients.

Generally, for the peer-to-peer model, one copy of each audio stream is received by each client. If unicast (point-to-point) routing is used, each client must transmit multiple copies of its audio stream upstream. However, if multi-cast (point-to-multipoint) routing is used each client needs only transmit one copy of its audio stream. In a system that uses unicast, the downstream bandwidth requirements on the client are therefore approximately equal to the upstream requirements. However, in a multicast system, the downstream requirements are approximately equal to n-times the upstream requirements, where n is the number of clients involved in the audio transmission.

In current situations, where sufficient bandwidth is available in the network and not cost constrained, the peer-to-peer model is preferable over other known methods because it distributes the mixing and associated computation among the multiple clients. This makes use of the computational resources available in the clients that would otherwise be unused, and reduces the computational burden on the server.

In bandwidth-restricted networks, upstream/ downstream bandwidth capacity to a given client restricts the number of audio streams that it can transmit/ receive simultaneously. Thus, in the peer-to-peer model, this implicitly limits the number of users or the quality (bandwidth) of each client's audio stream.

In the server-client model, a single mixed audio stream is transmitted downstream from the server to each client. Thus, the downstream bandwidth requirement to each client is equal to the bandwidth of a single audio stream, regardless of the number of streams being mixed in the server. One disadvantage of this method, however, is the increased processing load in the server, since it performs all of the mixing. This is particularly an issue if there are a large number of clients, and each client receives a different audio mix, as would be the case when each client mixes its own audio stream locally.

Thus, there is a need for one system that provides the benefits of both the server-client model and the peer-to-peer model by allowing the system to operate in either regime depending on the network state and the system requirements. For example, if the downstream bandwidth of the network is low, a mixer function could reside entirely in the server to minimize downstream bandwidth requirements. In a system where the downstream bandwidth is larger than the aggregate bandwidth of all upstream clients, audio streams could be routed directly to the clients in a peer-to-peer manner, and each client will mix the arriving streams. There is also a need for a system to operate somewhere in between the peer-to-peer and server-client regimes. For example, some audio streams could be mixed in the server, while others bypass the server and are mixed in the client(s).

### SUMMARY

In one embodiment, system architecture splits mixing functions between client and server to enable dynamic switching between a client-server and a peer-to-peer paradigm. In another embodiment, architecture allows one to efficiently trade-off computation in the server and link bandwidth in the network. In another embodiment a system is provided to minimize computational load on server subject to link bandwidth constraint. In another embodiment a system is provided to maximize use of client computational resources. In another embodiment a system is provided to adapt to changing network environments and changing service requirements (e.g. number of clients).

### BRIEF DESCRIPTION OF THE DRAWING

So the manner in which the above recited features of the present invention can be understood in detail, a more particular description of embodiments of the present invention, briefly summarized above, may be had by reference to embodiments, which is illustrated in the appended drawing. It is to be noted, however, the appended drawing illustrates only a typical embodiment of embodiments encompassed within the scope of the present invention, and, therefore, is not to be considered limiting, for the present invention may admit to other equally effective embodiments, wherein:

FIG. 1 depicts one embodiment of a system in accordance with embodiments of the present invention

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figure.

### DETAILED DESCRIPTION

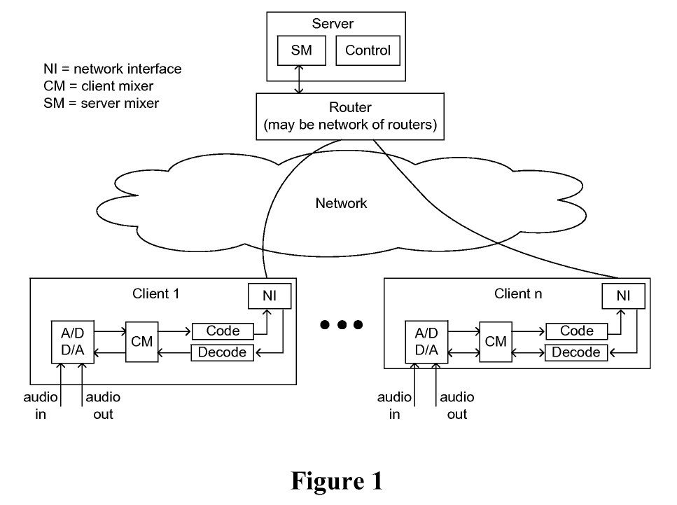

FIG. 1 depicts a system architecture in accordance with one embodiment of the present invention. In one embodiment, the server is connected to a router (or network of routers), and communicates to each client via a communication network.

In several embodiments, each client converts the input audio channel(s) into a single compressed digital music stream using an analog-to-digital converter, client mixer, and encoder. The order in which these operations are performed may vary depending on the implementation of the client. This stream is than transmitted upstream through the network interface to the router as shown in FIG. 1.

In embodiments utilizing a client-server operation, each client's music streams are forwarded from the router to the server, where they are processed. The processing operation in the server comprises a mixing operation in which multiple streams are mixed into a single stream that is transmitted downstream to each client. Each client may be sent an identical stream or an individually-catered stream depending on the application requirements. The client mixer receives the inbound stream(s) from router and mixes it with its local audio stream for playback or storage. In general, the mixing may be done in a manner that minimizes self-delay. The processing load on the server depends on the number of clients in the system. The bandwidth requirements of the network are that the upstream and downstream capacities between each client and the server generally must accommodate at least a single audio stream.

In situations where there is sufficient downstream bandwidth available to a given client (“Client A” the mixer controller may elect to configure the system so that audio streams from one or more of the other clients are routed directly to the Client A, completely bypassing the server. In general, Client A will receive audio streams that originate from either the server mixer or from other clients or both. In some embodiments, all received streams and Client A's local audio stream will be mixed in Client A's client mixer. More generally, in a system in which the downstream bandwidth to only some clients are sufficient to accommodate peer-to-peer, some audio mixes may be constructed in the server for those clients with insufficient downstream bandwidth to accommodate the unmixed audio streams, and those clients with sufficient downstream bandwidth may receive the unmixed (peer-to-peer) audio streams and mix them locally.

One task of the mixer controller is to determine what audio streams should be mixed in the server mixer and what audio streams should bypass the server mixer to be later mixed in the client mixer. At one extreme, in a pure server-client regime, all transmitted audio streams are mixed in the server mixer, and the client mixer only mixes a single received stream with the local audio stream. At the other extreme, the network operates in peer-to-peer mode, and all streams are mixed in the client mixers, so no processing is required in the server mixer.

The system can operate anywhere between the above two extremes in order to most effectively reduce the server-mixer processing load, while taking into account the bandwidth limitations of the network.

In some embodiments where a system has only two clients, each client receives a single audio stream from the other client and mixes it in the client mixer with its own local audio stream. In this situation, any server mixing operation is likely trivial, so shifting to peer-to-peer operation and pure client mixing reduces the load on the server, reduces the audio-stream transmission latency, and does not increase the processing on the client mixer.

In some embodiments, comprising systems with more than two clients, the configuration of the mixer controller becomes more complicated, depending on the performance constraints, and costs of bandwidth and processing in each part of the system. In addition to offloading computational burden from the server-mixer, one may also consider network latency when configuring the mixer controller. For example, if one client is farther away from the server, bypassing the server mixer could allow this stream to be received sooner by the other clients. This may simplify the mixing operation in the server because of the latency discrepancy between this distant client's stream and the others'. It could also reduced the overall latency of the distant client's audio stream since the client mixer operates on fewer streams and therefore may introduce less latency that the server mixer.

Network topology may also influence the mixer controller's operation. If two clients are on the same local-area network or sub-network, for example, the ability to route audio stream directly between the two clients (for client mixing) allows for lower transmission latency, reduced network traffic loading, and potentially higher bitrate audio streams.

In one embodiment, the system can be summarized from the perspective of each of the server, router, and clients as follows: (a) from the perspective of the client, each client may transmit its audio stream upstream, and mixes all received audio streams with the local version of its own audio stream, (b) from the perspective of the router, each received audio stream from the client side of the router may be forwarded to the server and/or may be forwarded to one or more of the clients, and (c) from the perspective of the server, received audio streams may be mixed and transmitted back to the clients via the router. The server may create one mix from the incoming audio streams to send to multiple clients, or it may create multiple mixes to send to different clients.

The operation of the router and mixer may be controlled by the server controller, which determines which mixes are created in the server mixer and which audio streams are routed where. However, even though audio streams may bypass the server mixer, it does not preclude the option of having copies sent to the server, either to be included in other mixes, or for other purposes specific to the application, such as archiving, editing, and analysis.

In one embodiment, the decision regarding the operation of each module is controlled by the mixer controller and may be governed by static (or slowly-varying) system parameters and/or by dynamic system parameters obtained from measurement and feedback mechanisms implemented in the router, server, and clients. Static or pseudo-static parameters include the number of clients, the topology of the network, the bandwidth (capacity) of the paths between clients and between each client and the server, and the processing limitations of the network server, while dynamic parameters could include the transient state and loading of the network and the resulting latency and available bandwidth on the paths between clients and each other and the server.

While the foregoing is directed to embodiments of the present invention, other and further embodiments of the invention may be devised without departing from the basic scope thereof. It is understood that various embodiments described herein may be utilized in combination with any other embodiment described, without departing from the scope contained herein.

What is claimed is:

1. A data mixer comprising:
a first input for receiving a first data signal from a first client;
a first input for receiving a second data signal from a second client;
a mixing means for mixing the first and second data signals;
a first unique data mix, for the first client; and
a second unique data mix, for the second client.
